(19) United States
(12) Patent Application Publication
(10) Pub. No.: US 2013/0166809 A1
(43) Pub. Date: Jun. 27, 2013

(54) DRIVE CIRCUIT FOR PERIPHERAL COMPONENT INTERCONNECT-EXPRESS (PCIE) SLOTS

(71) Applicants: GUI-FU XIAO, Shenzhen City (CN); CHENG-FEI WENG, Shenzhen City (CN); YANG LIU, Shenzhen City (CN)

(72) Inventors: GUI-FU XIAO, Shenzhen City (CN); CHENG-FEI WENG, Shenzhen City (CN); YANG LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/483,062

(22) Filed: May 30, 2012

(30) Foreign Application Priority Data
Dec. 24, 2011 (CN) 201110438361.0

(51) Int. Cl. G06F 13/14

(52) U.S. Cl. 710/305

(57) ABSTRACT

A drive circuit is used in an electronic device comprising multiple peripheral component interconnect-express (PCIE) slots. The drive circuit includes a motherboard, a first signal generation circuit, a second signal generation circuit, and a first delay circuit. The motherboard provides a control signal to the first signal generation circuit and the first delay circuit. The first signal generation circuit outputs immediate drive signals to first multiple PCIE slots. The first delay circuit outputs a first delay control signal to the second signal generation circuit after a predetermined time. The second signal generation circuit outputs drive signals to drive second multiple PCIE slots.

### BACKGROUND

1. Technical field

The disclosure generally relates to drive circuits, and particularly to a drive circuit for card devices.

2. Description of the Related Art

A motherboard integrates a number of peripheral component interconnect-express (PCIE) slots, for the installation of card devices, such as a network card, a display card, an audio card, or a redundant array of independent disks (RAID) card. When the motherboard is powered on, the card device will be enabled at the same time. However, a total power consumption of the card device may exceed 100 watts, or even approach the rated power limit of a power supply of an electronic device. Thus, the electronic device may not be able to receive a full power supply to start, and the power supply may be damaged.

Therefore, there is room for improvement within the art.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment.

FIG. 1 is a block diagram of a drive circuit for PCIE slots, according to a first exemplary embodiment.

FIG. 2 is a circuit diagram of a delay circuit of the drive circuit of FIG. 1.

FIG. 3 is a circuit diagram of a first signal generation circuit of the drive circuit of FIG. 1.

FIG. 4 is a circuit diagram of a second signal generation circuit of the drive circuit of FIG. 1.

FIG. 5 is a block diagram of a drive circuit for PCIE slots, according to a second exemplary embodiment.

### DETAILED DESCRIPTION

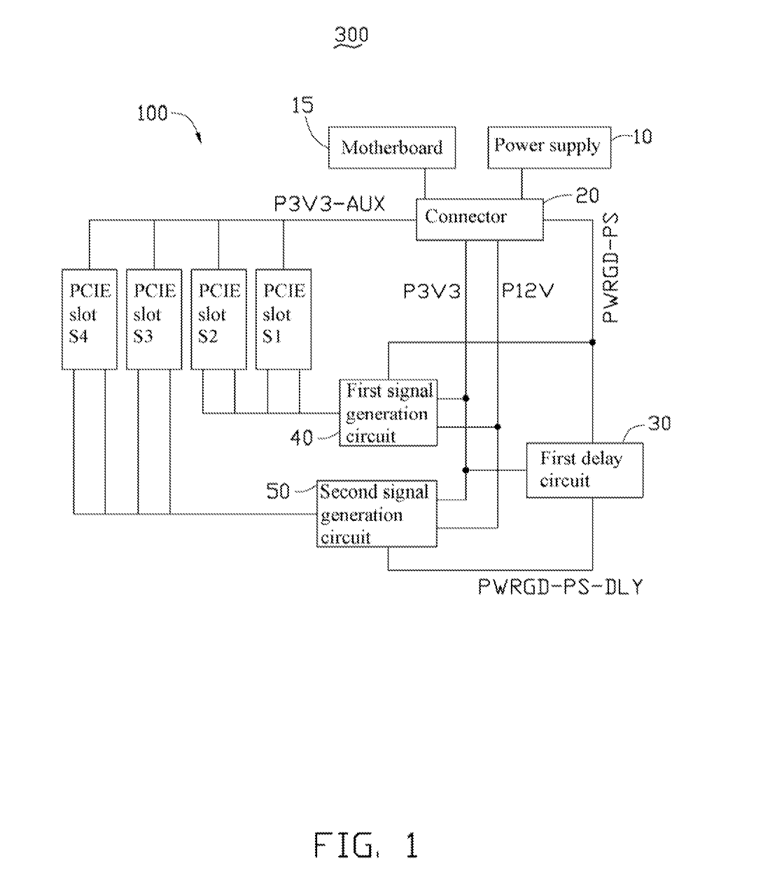

FIG. 1 shows a drive circuit 100 for multiple PCIE slots, according to a first exemplary embodiment. The drive circuit 100 can be used in an electronic device 300 such as a server, for example. The multiple PCIE slots can accept and govern network cards, display cards, audio cards, RAID cards, or other card devices.

In one exemplary embodiment, the drive circuit 100 is used to provide drive signals to four PCIE slots S1-S4, which drive the card devices connected to the four PCIE slots S1-S4. The drive circuit 100 includes a power supply 10, a motherboard 15, a connector 20, a first delay circuit 30, a first signal generation circuit 40, and a second signal generation circuit 50.

The power supply 10 provides three working voltages, respectively labeled as P3V3_AUX, P3V3, and P12V. The four PCIE slots S1-S4 are electronically connected to the power supply 10 via the connector 20, to obtain the working voltage P3V3_AUX. Both the first signal generation circuit 40 and the second signal generation circuit 50 are electronically connected to the power supply 10 via the connector 20, and respectively receive the working voltages P3V3 and P12V.

The motherboard 15 outputs a control signal PWRGD-PS when the electronic device 300 is turned on, the control signal PWRGD-PS may be a digital signal such as logic “1”, or an analog voltage signal of 3V or 5V. Both the first delay circuit 30 and the first signal generation circuit 40 are electronically connected to the motherboard 15 via the connector 20, to receive the control signal PWRGD-PS.

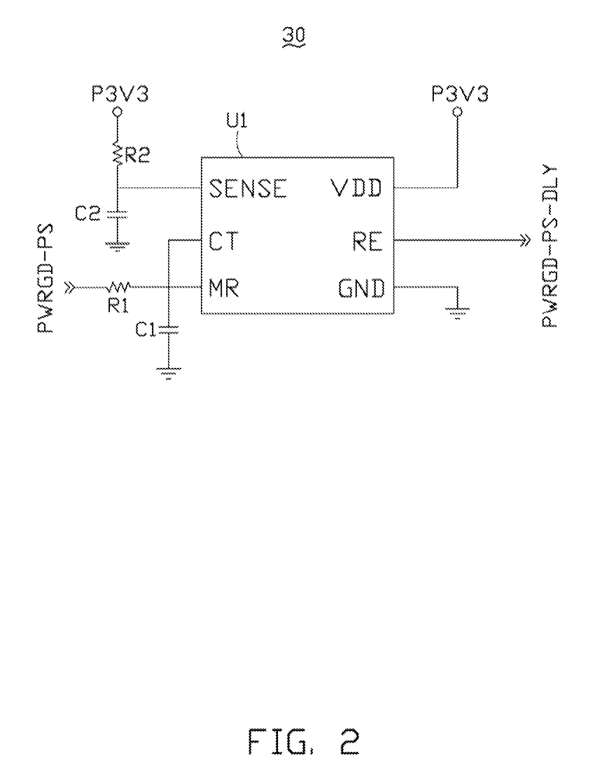

Referring to FIG. 2, the first delay circuit 30 receives the control signal PWRGD-PS, and outputs a first delay control signal PWRGD-PS-DLY. The first delay control signal PWRGD-PS-DLY may be a digital signal such as logic “1”, or an analog voltage signal of 3V or 5V. The first delay circuit 30 includes a delay microchip U1, resistors R1, R2, and capacitors C1, C2. The delay microchip U1 includes a power pin VDD, an input pin MR, a setting pin CT, a sensing pin SENSE, a ground pin GND, and an output pin RE. The power pin VDD is electronically connected to the working voltage P3V3. The input pin MR is electronically connected to the motherboard 15 via the resistor R1 and the connector 20, to receive the control signal PWRGD-PS. The sensing pin SENSE is electronically connected to the working voltage P3V3 via the resistor R2, and is connected to ground via the capacitor C2. The output pin RE outputs the first delay control signal PWRGD-PS-DLY. The setting pin CT is connected to ground via the capacitor C1, and a delay time of the delay microchip U1 is predetermined by the capacitance value of the capacitor C1. In one exemplary embodiment, the capacitance value of the capacitor C1 may be about 150 nF, and the predetermined delay time of the delay microchip U1 may be about 0.86 seconds (0.86s). In other words, a time between the delay microchip U1 receiving the control signal PWRGD-PS and the delay microchip U1 outputting the first delay control signal PWRGD-PS-DLY is about 0.86 s.

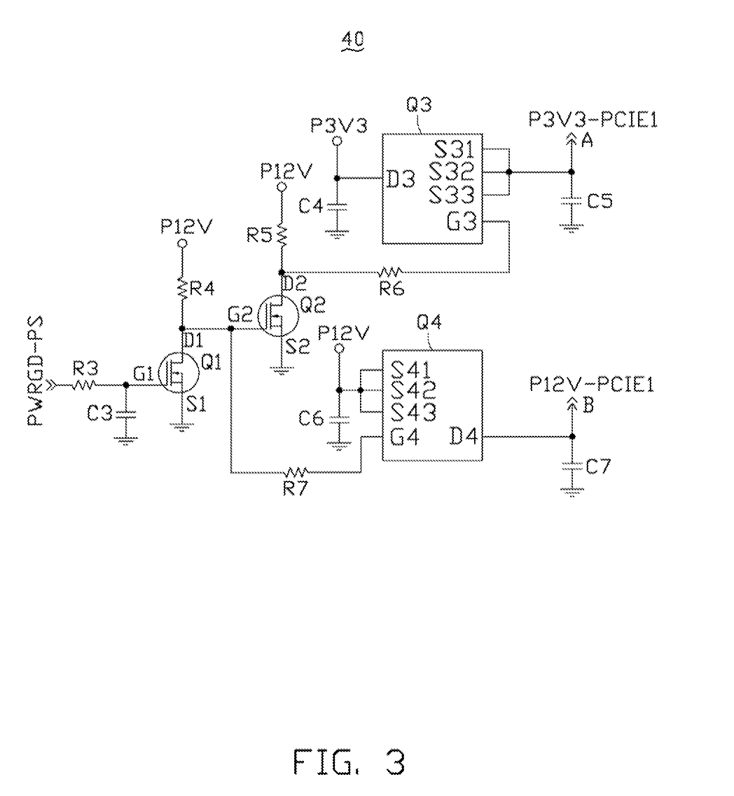

Referring to FIG. 3, the first signal generation circuit 40 outputs drive signals P3V3-PCIE1 and P12V-PCIE1 to the PCIE slots S1-S2. The first signal generation circuit 40 includes a first metal oxide semiconductor field effect transistor (MOSFET) Q1, a second MOSFET Q2, a third MOSFET Q3, a fourth MOSFET Q4, resistors R3-R7, and capacitors C3-C7. Each of the first MOSFET Q1, the second MOSFET Q2, and the third MOSFET Q3 is an N-channel component, and the fourth MOSFET Q4 is a P-channel component.

The first MOSFET Q1 includes a gate G1, a source S1, and a drain D1. The gate G1 is electronically connected to the connector 20 via the resistor R3, to receive the control signal PWRGD-PS, and the gate G1 is connected to ground via the capacitor C3. The source S1 is connected the ground, and the drain D1 is electronically connected to the working voltage P12V via the resistor R4. The second MOSFET Q2 includes a gate G2, a source S2, and a drain D2. The gate G2 is electronically connected to drain D1, the source S2 is connected the ground, and the drain D2 is electronically connected to the working voltage P12V via the resistor R5.

Each of the third MOSFET Q3 and the fourth MOSFET Q4 is in the form of an 8-pin microchip, and is used to stabilize output voltages. The third MOSFET Q3 includes a gate G3, a drain D3, and sources 531, S32, S33. The gate G3 is electronically connected to the drain D2 via the resistor R6, the drain D3 is electronically connected to working voltage P3V3, and is connected the ground via the capacitor C4. The sources S31, S32, S33 are electronically interconnected, and are connected to ground via the capacitor C5. The sources S31, S32, S33 function as a first output port A of the first signal generation circuit 40. The first output port A is electronically connected to the PCIE slots S1-S2, to provide the drive signal P3V3-PCIE1 to the PCIE slots S1-S2, according to the working voltage P3V3. The fourth MOSFET Q4 includes a gate G4, a drain D4, and sources S41, S42, S43. The gate G4 is electronically connected to the drain D1 via the resistor R7, the sources S31, S32, S33 are electronically interconnected. The sources S31, S32, S33 are electronically connected to working voltage P12V, and are connected to ground via the capacitor C6. The drain D4 is connected to ground via the capacitor C7, and functions as a second output port B of the first signal generation circuit 40. The second output port B is electronically connected to the PCIE slots S1-S2, to provide the drive signal P12V-PCIE1 to the PCIE slots Sl-S2, according to the working voltage P12V.

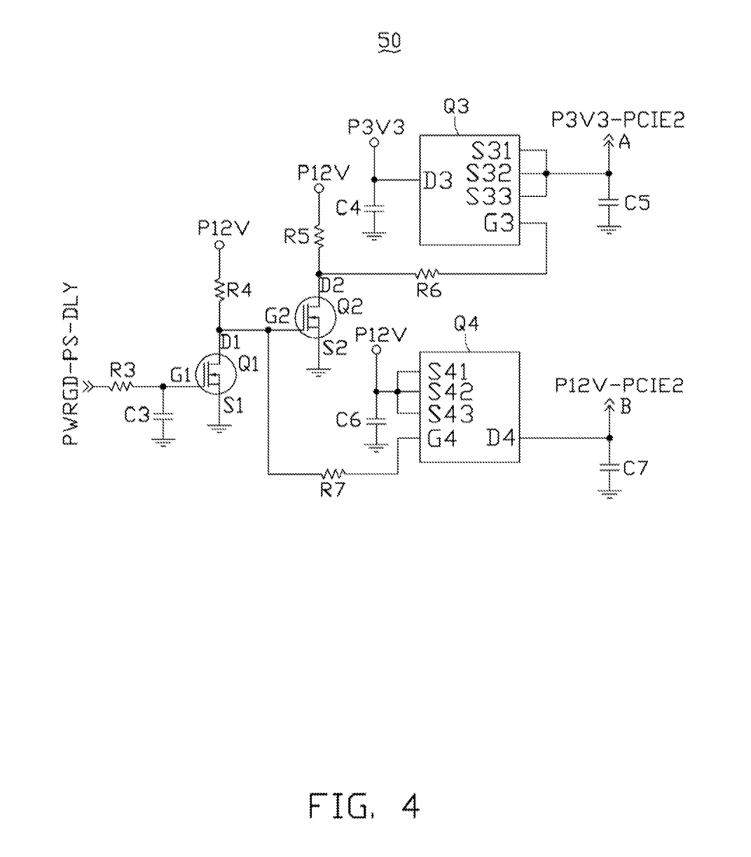

Referring to FIG. 4, the second signal generation circuit 50 is the same as the first signal generation circuit 40. In one exemplary embodiment, the second signal generation circuit 50 outputs drive signals P3V3-PCIE2 and P12V-PCIE2 to the PCIE slots S3-S4. The gate G1 of the second signal generation circuit 50 is electronically connected to the output pin RE of the delay microchip U1, to receive the first delay control signal PWRGD-PS-DLY. The first output port A of the second signal generation circuit 50 is electronically connected to the PCIE slots S3-S4, to provide the drive signal P3V3-PCIE2 to the PCIE slots S3-S4, according to the working voltage P3V3. The second output port B of the second signal generation circuit 50 is electronically connected to the PCIE slots S3-S4, to provide the drive signal P12V-PCIE2 to the PCIE slots S3-S4, according to the working voltage P12V.

When the electronic device 300 is turned on, the motherboard 15 outputs the control signal PWRGD-PS to the first signal generation circuit 40. The first MOSFET Q1 is turned on, a voltage of the drain D1 is pulled down, so the second MOSFET Q2 is turned off, the third MOSFET Q3 is turned on, and the fourth MOSFET Q4 is turned on. Thus, the first output port A and the second output port B of the first signal generation circuit 40 respectively output the drive signals P3V3-PCIE1 and P12V-PCIE1 to the PCIE slots S1-S2. Therefore, the card devices connected to the PCIE slots S1-S2 are enabled according to the drive signals P3V3-PCIE1 and P12V-PCIE1.

Additionally, the motherboard 15 outputs the control signal PWRGD-PS to the delay microchip U1 via the resistor R1, and the delay microchip U1 outputs the delay control signal PWRGD-PS to the second signal generation circuit 50 after the predetermined delay time (about 0.86 S). Then, the first output port A and the second output port B of the second signal generation circuit 50 respectively output the drive signals P3V3-PCIE2 and P12V-PCIE2 to the PCIE slots S3-S4. Therefore, the card devices connected to the PCIE slots S3-S4 are enabled according to the drive signals P3V3-PCIE2 and P12V-PCIE2. The card devices connected to the PCIE slots S1-S2 and the PCIE slots S3-S4 will be enabled at different times, thus allowing the electronic device 300 to start smoothly and normally because a total power consumption of a proportion of the PCIE slots S1-S4 is less than a rated power level of the power supply 10.

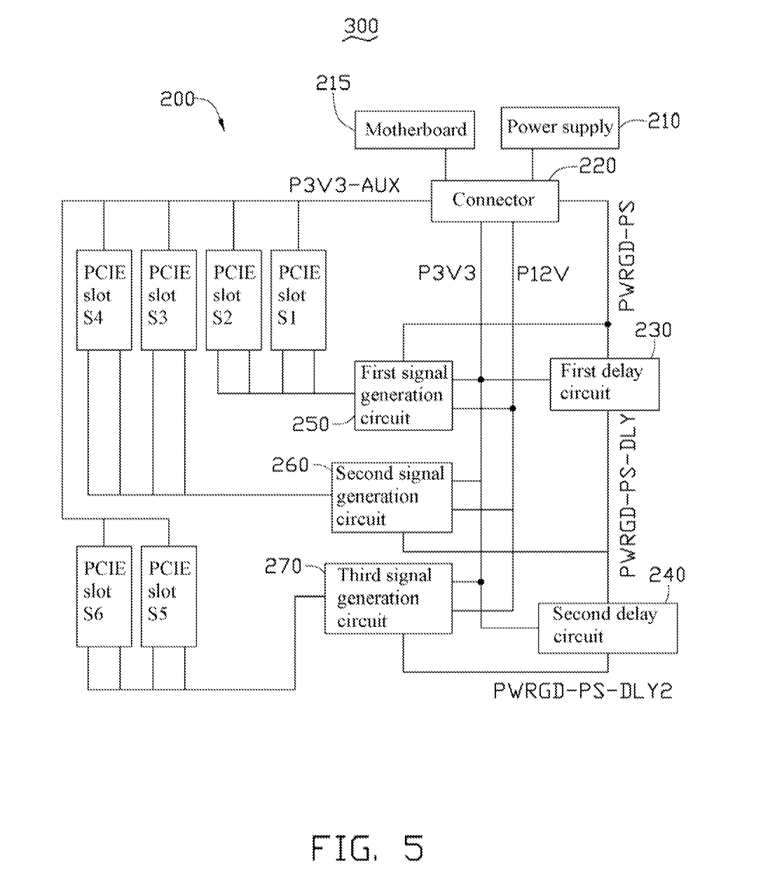

FIG. 5 shows a drive circuit 200 for PCIE slots, according to a second exemplary embodiment. The drive circuit 200 provides working voltages to six PCIE slots S1-S6, and includes a power supply 210, a motherboard 215, a connector 220, a first delay circuit 230, a second delay circuit 240, a first signal generation circuit 250, a second signal generation circuit 260, and a third signal generation circuit 270. The first delay circuit 230 and the second delay circuit 240 are the same as the first delay circuit 30 of the first exemplary embodiment. The first signal generation circuit 250, the second signal generation circuit 260, and the third signal generation circuit 270 are substantially the same as the first signal generation circuit 40 of the first exemplary embodiment. The power supply 210, the motherboard 215, and the connector 220 are the equivalents of the power supply 10, the motherboard 15, and the connector 20 of the first exemplary embodiment, respectively.

In the second exemplary embodiment, the first delay circuit 230 is electronically connected to the motherboard 215 via the connector 220, and the second delay circuit 240 is electronically connected between the first delay circuit 230 and the third signal generation circuit 270. The first signal generation circuit 250 receives a control signal PWRGD-PS from the motherboard 215, and outputs drive signals P3V3-PCIE1 and P12V-PCIE1 to the PCIE slots S1-S2. The first delay circuit 230 receives the control signal PWRGD-PS and outputs a first delay control signal PWRGD-PS-DLY to the second signal generation circuit 260, and the second signal generation circuit 260 outputs drive signals P3V3-PCIE2 and P12V-PCIE2 to the PCIE slots S3-S4. The second delay circuit 240 receives the first delay control signal PWRGD-PS-DLY and outputs a second delay control signal PWRGD-PS-DLY2 to the third signal generation circuit 270, and the third signal generation circuit 270 outputs drive signals P3V3-PCIE3 and P12V-PCIE3 to the PCIE slots S5-S6.

In other embodiments, the first signal generation circuit 40 is used to drive the PCIE slot S1, and the second signal generation circuit 50 is used to drive the PCIE slots S2-S4.

The first signal generation circuit 40/250 provides drive signals P3V3-PCIE1 and P12V-PCIE1 to only some of multiple PCIE slots, and the second signal generation circuit 50/260 provides drive signals P3V3-PCIE2 and P12V-PCIE2 to the remaining multiple PCIE slots. The voltage signals P3V3-PCIE2 and P12V-PCIE2 are delayed relative to the drive signals P3V3-PCIE1 and P12V-PCIE1 because of the first delay circuit 30/230. Thus, the PCIE slots will not be enabled simultaneously, allowing the electronic device 300 full power to start normally.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A drive circuit for an electronic device comprising multiple peripheral component interconnect-express (PCIE) slots, comprising:
a motherboard configured for providing a control signal;
a first delay circuit electronically connected to the motherboard;
a first signal generation circuit electronically connected to the motherboard; and
a second signal generation circuit electronically connected to the first delay circuit;
wherein the first signal generation circuit receives the control signal and outputs drive signals to first multiple PCIE slots, the first delay circuit receives the control signal and outputs a first delay control signal after a predetermined delay time, and the second signal generation circuit receives the first delay control signal and outputs drive signals to second multiple PCIE slots, wherein the first multiple PCIE slots are different from the second multiple PCIE slots.

2. The drive circuit as claimed in claim 1, further comprising a power supply and a connector, wherein the power supply is electronically connected to the first signal generation circuit, the second signal generation circuit, and the PCIE slots via the connector, to provide working voltages to the first signal generation circuit, the second signal generation circuit, and the PCIE slots.

3. The drive circuit as claimed in claim 2, wherein both of the first signal generation circuit and the first delay circuit are electronically connected to the motherboard via the connector to receive the control signal.

4. The drive circuit as claimed in claim 2, wherein both of the first signal generation circuit and the second signal generation circuit output the drive signals according to the working voltages.

5. The drive circuit as claimed in claim 4, wherein the first signal generation circuit includes a first metal oxide semiconductor field effect transistor (MOSFET) and a second MOSFET both comprising a gate, a source, and a drain, the gate of the first MOSFET is electronically connected to the motherboard to receive the control signal, the drain of the first MOSFET is electronically connected to one of the working voltages, the gate of second MOSFET is electronically connected to the drain of the first MOSFET, and the drain of the second MOSFET is electronically connected to the one of the working voltages.

6. The drive circuit as claimed in claim 5, wherein the first signal generation circuit further includes a third MOSFET comprising a gate, three sources, and a drain, the gate of the third MOSFET is electronically connected to the drain of the second MOSFET, the drain of the third MOSFET is electronically connected to another one of the working voltages, and the three sources of the third MOSFET are electronically interconnected to output the drive signals.

7. The drive circuit as claimed in claim 6, wherein the first signal generation circuit further includes a fourth MOSFET comprising a gate, three sources, and a drain, the gate of the fourth MOSFET is electronically connected to the drain of the first MOSFET, the three sources of the fourth MOSFET are electronically interconnected, and are electronically connected to the one of the working voltages, the drain of the fourth MOSFET outputs the drive signals.

8. The drive circuit as claimed in claim 7, wherein each of the first MOSFET, the second MOSFET, and the third MOSFET is an N-channel electric component, and the fourth MOSFET is a P-channel electric component.

9. The drive circuit as claimed in claim 8, wherein the second signal generation circuit is the same as the first signal generation circuit.

10. The drive circuit as claimed in claim 1, wherein the first delay circuit includes a delay microchip comprising an input pin and an output pin, the input pin is electronically connected to the motherboard, and the output pin is electronically connected to the second signal generation circuit.

11. The drive circuit as claimed in claim 10, wherein the delay microchip further includes a setting pin connected to ground via a capacitor, and the predetermined delay time is predetermined by a capacitance value of the capacitor.

12. The drive circuit as claimed in claim 1, further comprising a second delay circuit electronically connected to the first delay circuit, the second delay circuit receives the first delay control signal, and outputs a second delay control signal accordingly.

13. The drive circuit as claimed in claim 12, further comprising a third signal generation circuit electronically connected to the second delay circuit, the third signal generation circuit receives the second delay control signal and outputs drive signals to another multiple PCIE slots.

14. A drive circuit for an electronic device comprising multiple peripheral component interconnect-express (PCIE) slots, comprising:
a motherboard configured for providing a control signal;
a first signal generation circuit electronically connected to the motherboard to receive the control signal and accordingly output drive signals to first multiple PCIE slots;
a first delay circuit electronically connected to the motherboard to receive the control signal and accordingly output a first delay control signal after a predetermined delay time; and
a second signal generation circuit electronically connected to the first delay circuit to receive the first delay control signal and accordingly output drive signals to second multiple PCIE slots;
wherein the first multiple PCIE slots are different from the second multiple PCIE slots.

15. The drive circuit as claimed in claim 14, further comprising a power supply and a connector, the power supply is electronically connected to the first signal generation circuit and the second signal generation circuit via the connector, to provide working voltages to the first signal generation circuit and the second signal generation circuit.

16. The drive circuit as claimed in claim 15, wherein both of the first signal generation circuit and the second signal generation circuit output the drive signals according to the working voltages.

17. A drive circuit for an electronic device comprising a plurality of peripheral component interconnect-express (PCIE) slots, comprising:
a motherboard configured for providing a control signal;
a first signal generation circuit electronically connected to the motherboard to receive the control signal and accordingly output drive signals to a first part of the plurality of PCIE slots;
a first delay circuit electronically connected to the motherboard to receive the control signal and accordingly output a first delay control signal after a predetermined delay time;
a second signal generation circuit electronically connected to the first delay circuit to receive the first delay control signal and accordingly output drive signals to a second part of the plurality of PCIE slots;
a second delay circuit electronically connected to the first delay circuit to receive the first delay control signal, and accordingly output a second delay control signal after a predetermined delay time; and
a third signal generation circuit electronically connected to the second delay circuit to receive the second delay control signal and accordingly output drive signals to a third part of the plurality of PCIE slots;
wherein the first part, second part, and third part of the plurality of PCIE slots are different from each other.

18. The drive circuit as claimed in claim 17, further comprising a power supply and a connector, the power supply is electronically connected to the first signal generation circuit, the second signal generation circuit, and the third signal generation circuit via the connector, to provide working voltages to the first signal generation circuit, the second signal generation circuit, and the second signal generation circuit.
